(19) United States
(12) Patent Application Publication
(10) Pub. No.: US 2008/0143507 A1
(43) Pub. Date: Jun. 19, 2008

(54) TIRE PRESSURE MONITORING SYSTEM FOR ASSOCIATING TIRE PRESSURE MONITORING SENSORS WITH WHEEL LOCATIONS ON A VEHICLE

(75) Inventors: Kevin Cotton, Fenton, MI (US); Jason Summerford, Novi, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/551,908

(22) Filed: Oct. 23, 2006

(51) Int. Cl. B60C 23/00

(52) U.S. Cl. 340/445; 340/447

(57) ABSTRACT

The embodiments described herein include a tire pressure monitoring (TPM) system and method for a vehicle having multiple wheels. The system and method provide an efficient means for accurately associating TPM sensors on the vehicle with specific vehicle wheel locations.

### TECHNICAL FIELD

The embodiments described herein relate to a tire pressure monitoring system for associating TPM sensors with specific wheels on a vehicle.

### BACKGROUND

Tire pressure monitoring (TPM) systems that include TPM sensors are installed on vehicles for providing vehicle occupants information relating to the condition of vehicle wheels. Conventionally, the TPM sensors are contained within the tires on the vehicle. The TPM system also includes a receiver, installed on the vehicle, for receiving signals from the TPM sensor. Typically, the TPM sensors are installed on the wheels prior to the wheels being mounted on the vehicle. So that the TPM system can notify vehicle occupants of tire conditions with respect to specific wheel locations, it is required that the receiver be able to accurately identify which TPM sensors are associated each vehicle wheel location. For example, the receiver should be able to determine, by TPM sensor identifications, which TPM sensors are located on the front-right, front-left, rear-right and rear-left wheels. Accordingly, the receiver must be programmed to know which vehicle wheels have certain TPM sensors.

Conventionally, to teach the receiver which vehicle wheels are associated with the respective TPM sensors, low frequency (LF) initiators are installed on the vehicle. These LF initiators generate signals that force a response from the TPM sensors that enable the receiver to learn which TPM sensors are associated with the vehicle wheel locations. However, the LF initiators are costly and complicate the installation of TPM systems on vehicles.

The embodiments described herein were conceived in view of these and other disadvantages of conventional TPM systems.

### SUMMARY

The embodiments described herein include a tire pressure monitoring (TPM) system and method for a vehicle having multiple wheels. The system includes a TPM sensor contained in each of the vehicle wheels wherein the sensor is configured to transmit TPM sensor signals. A plurality of antennas for receiving the TPM sensor signals are included wherein one antenna is positioned in close proximity to each TPM sensor. A receiver is included that is in communication with the antennas. The receiver also includes an antenna switch and a controller wherein the antenna switch enables the TPM sensor signals to be received and processed by the controller. The controller determines the location of the TPM sensor that transmitted the TPM sensor signal based on the processed TPM sensor signal.

### BRIEF DESCRIPTION OF THE DRAWINGS

The features described herein are set forth with particularity in the appended claims. The present embodiments, both as to its organization and manner of operation, together with further advantages thereof, may be best understood with reference to the following description, taken in connection with the accompanying drawings in which:

FIG. 1 illustrates a vehicle having a tire pressure monitoring (TPM) system in accordance with an embodiment of the present invention;

FIGS. 2A and 2B illustrate a flow chart for associating TPM sensors on a vehicle with vehicle wheels; and

FIG. 3 illustrates yet another embodiment of a flow chart for associating TPM sensors with vehicle wheels.

### DETAILED DESCRIPTION OF THE PREFERRED EMBODIMENT(S)

As required, detailed embodiments are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific functional details disclosed herein are not to be interpreted as limiting, but merely as a representative basis for the claims and/or as a representative basis for teaching one skilled in the art to variously employ in the present invention.

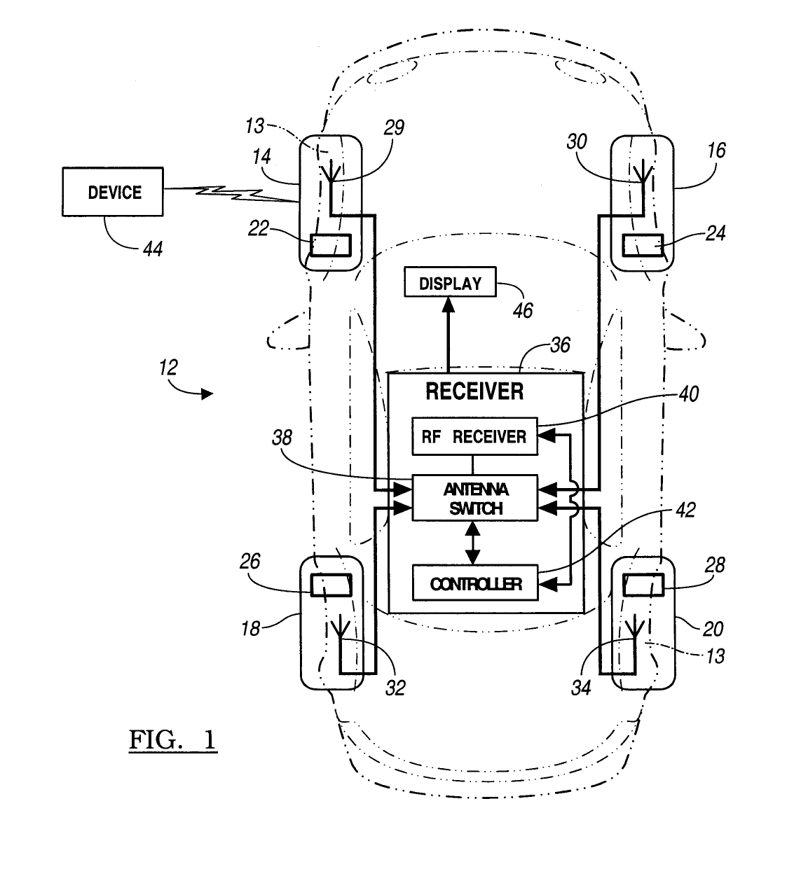

Referring to FIG. 1, a vehicle 12 is shown having a tire pressure monitoring (TPM) system in accordance with an embodiment of the present invention. The TPM sensor system described herein is configured to associate or locate TPM sensors with specific vehicle wheels in a cost and time efficient manner. The present embodiments enable the use of lower powered TPM sensor sensors thereby reducing the chance of wireless signal collisions. The embodiments herein also enable a TPM system that is capable of meeting low-power regulatory requirements.

Vehicle 12 includes vehicle wheels 14, 16, 18 and 20. Contained within the vehicle wheels 14, 16, 18 and 20 are TPM sensors 22, 24, 26 and 28, respectively. It is recognized that vehicle 12 is merely exemplary and other vehicles having more or less wheels with TPM sensors are contemplated by the teachings of the present invention. As would be recognized by one of ordinary skill in the art, the TPM sensors 22, 24, 26 and 28 are configured to sense the condition (e.g., tire pressure) of the wheels 14, 16, 18 and 20, and wirelessly transmit TPM sensor signals relating to the wheel condition. The TPM sensor signals may also include sensor identification data that identifies the TPM sensor from which the TPM sensor signals were transmitted. As described herein, the TPM sensors 22, 24, 26 and 28 may be used to teach the TPM sensor system their specific location with respect to the vehicle wheels 14, 16, 18 and 20.

As shown, a plurality of antennas 29, 30, 32 and 34 are located in close proximity (e.g., within 24 inches) to the TPM sensors 22, 24, 26 and 28, respectively. These antennas enable the reception of signals from the TPM sensors 22, 24, 26 and 28 for a receiver 36. In one embodiment, the antennas 29, 30, 32 and 34 are mounted to or near a wheel well 13 of the vehicle as shown in FIG. 1. Because the antennas 29, 30, 32 and 34 are in close proximity to the TPM sensors low-powered TPM sensors may be utilized. As such, costs associated with the TPM sensors are reduced and the likelihood of signal collision by TPM sensor signals is minimized.

As stated above, antennas 29, 30, 32 and 34 provide signals to a receiver 36. The receiver 36 includes an antenna switch 38, a radio frequency (RF) receiver 40, and a controller 42. Antenna switch 38 is adapted to allow signals received by antennas 29, 30, 32 and 34 to be coupled to and processed by controller 42. RF receiver 40 is coupled to and communicates with the antenna switch 38 and the controller 42. RF receiver 40 is configured to process the TPM sensor signals initially received by the antennas 29, 30, 32 and 34 and amplify the received signals so as to be compatible with controller 42.

Antenna switch 38 is configured to couple and decouple the antennas from controller 42. In one embodiment, controller 42 controls coupling and decoupling of antennas 29, 30, 32 and 34 to and from controller 42. Controller 42, which has memory storage and data processing functionality, generates control signals for antenna switch 38 to selectively “turn-on” and “turn-off” (i.e., couple and decouple) each antenna 29, 30, 32 and 34 to controller 42. Coupling antennas 29, 30, 32 and 34 to controller 42 enables the reception and processing of TPM sensor signals.

Selective coupling of antennas 29, 30, 32 and 34 to controller 42 occurs in accordance with a predetermined polling sequence. The predetermined polling sequence is programmed into the memory of controller 42 and provides a sequence for polling (i.e., coupling) of antennas 29, 30, 32 and 34 to controller 42. For example, controller 42 may have a polling sequence that provides that antenna switch 38 couple antennas 29, 30, 32 and 34, one at a time, in the following sequence: antenna 29 first, antenna 30 second, antenna 32 third and antenna 34 fourth. It is recognized that the polling sequence may vary according to TPM system design and/or operational requirements.

Controller 42 is also programmed to include a received signal strength indicator (RSSI) for determining the signal strength of the TPM sensor signals as received by antennas 29, 30, 32 and 34. Additionally, during the processing of TPM sensor signals by controller 42, the sensor identification (ID) that identifies the TPM sensors that generated the TPM sensor signals may be identified and recorded (i.e., stored in memory). As will be described hereinafter, via controller 42, the signal strength and sensor ID of the TPM sensor signals are used to teach the TPM system the location of TPM sensors with respect to the vehicle wheels. A display 46 communicates with receiver 36 to visually and/or audibly provide TPM system information to vehicle occupants. For instance, display 46 may display the condition of wheel 16 and sensed by TPM sensor 24.

When wheels 14, 16, 18 and 20, having TPM sensors 22, 24, 26 and 28, respectively, are mounted on the vehicle, the TPM system does not know the specific location of TPM sensors 22, 24, 26 and 28 with respect to wheels 14, 16, 18 and 20. For example, receiver 36 does not know that wheel 14 contains TPM sensor 22, wheel 16 contains TPM sensor 24 and the like. It is desired that the TPM system know the specific location of TPM sensors 22, 24, 26, and 28 with respect to wheels 14, 16, 18 and 20 so that information provided to vehicle occupants via display 46 is accurate.

To teach the TPM sensor system the location of the TPM sensor with respect to the vehicle wheels, the TPM sensor system has a learn mode. In the learn mode the receiver is adapted to receive and process TPM sensor signals from the TPM sensors 22, 24, 26 and 28 to determine the specific location with respect to the vehicle wheels 14, 16, 18 and 20. In some embodiments, the learn mode may be entered through the use of an electronic message to the receiver 36, by engaging a learn mode button located on the vehicle, or cycling an ignition of the vehicle. In some aspects of the invention, there are multiple learn modes including a “factory” learn mode and a “customer” learn mode. The factory learn mode is typically utilized when the vehicle is first assembled or the TPM system is installed on the vehicle. The customer learn mode is typically used when the vehicle tires are rotated or exchanged. Regarding the customer learn mode, controller 42 is programmed with a predetermined drive period by which controller 42 monitors the signal strength of generated TPM sensors to access whether the generated TPM sensors were intended or were undesirable transmission anomalies.

One optional distinction between the factory learn mode and the customer learn mode is the use of a triggering device 44. As will be described hereinafter, triggering device 44 may be used in the factory learn mode to initiate or trigger TPM sensors when teaching the TPM system the location of TPM sensors with respect to the vehicle wheels. It is recognized, however, that in some embodiments triggering device 44 may be utilized in both the factory and customer learn modes. In one embodiment triggering device 44 may trigger TPM sensors 22, 24, 26 and 28 via a low-frequency (LF) signal. Triggering device 44 may be virtually any device capable of initiating/triggering a TPM sensor system. Such triggering devices are available from Bartec USA, LLC, 6543 Arrow Drive, Sterling Heights, Mich. 48314. Alternatively, it is recognized that some embodiments may not utilize a device such as triggering device 44. In such embodiments, a vehicle mounted triggering device may be used.

Nevertheless, once the learn mode has been initiated, in accordance with the polling sequence, one of the antennas 29, 30, 32 and 34 is coupled to receiver 36 (i.e., controller 42). For example, antenna 29 may be the first antenna polled in accordance with the polling sequence. A user may utilize triggering device 44 that generates a radio-frequency (RF) trigger signal to cause the TPM sensors 22, 24, 26 and 28 to generate the TPM sensor signals. The generation of the RF trigger signal for TPM sensors 22, 24, 26 and 28 is in accordance with a predetermined triggering sequence. Accordingly, triggering device 44 is programmed with the predetermined triggering sequence. In accordance with the predetermined triggering sequence triggering device 44 generates the RF trigger signals for TPM sensors 22, 24, 26 and 28 in a particular order. In the instant example, TPM sensor 22 may be the first TPM sensor to receive the RF trigger signal. Subsequently, triggering device 44 may generate the RF trigger signal for TPM sensor 24. Next, the RF trigger signal may be generated for the TPM sensor 26 followed by a RF trigger signal for TPM sensor 28.

Receiver 36, via controller 42, is also programmed with the predetermined triggering sequence. In one embodiment, although not necessarily, the predetermined triggering sequence is the same as the predetermined polling sequence. As such, when the learn mode is entered, the receiver 36 knows when specific TPM sensors will be triggered by the RF trigger signals generated by triggering device 44.

It is recognized that although, in this example, TPM sensor 22 is intended to be triggered by the RF trigger signal, other TPM sensors (i.e., TPM sensors 24, 26 and 28) may also receive the RF trigger signal by virtue of their proximity to triggering device 44. Nevertheless, once the TPM sensors 22, 24, 26 and 28 receive the RF trigger signal, each TPM sensor generates the TPM sensor signals having the respective sensor IDs that identify which TPM sensor generated the TPM sensor signal. The antenna in closest proximity to each TPM sensor receives the TPM sensor signal generated by that TPM sensor. In the embodiments described herein, the antennas in closest proximity to the TPM sensors are the antennas located in the wheel well that is adjacent to that wheel. For example, the antenna 29 would receive the TPM sensor signal generated by TPM sensor 22.

Once the antennas 29, 30, 32 and 34 receive the transmitted TPM sensor signals, controller 42 then receives the TPM sensor signals. Accordingly, each sensor ID is identified and recorded. Additionally, through the use of the RSSI, the signal strength of the received TPM sensor signals is accessed. The controller identifies the TPM sensor having generated the TPM sensor signal with the highest signal strength. In this example, because antenna 29, which is located at wheel 14, was being polled and TPM sensor 22 was triggered, TPM sensor 22 should be the TPM sensor that generated the TPM sensor signal with the highest signal strength. Accordingly, TPM sensor will be associated with the front-left wheel 14. This association of TPM sensor 22 with wheel 14 will be stored in memory of controller 42.

A second antenna (e.g., antenna 30) will be polled since a first antenna (i.e., antenna 29) has been associated with a specific wheel. As such, antenna 30 will be coupled to receiver 36 and triggering device 44 will generate an RF trigger signal for TPM sensor 24. As described above, it is likely that other TPM sensors (e.g., 22, 26 and 28) may generate TPM sensor signals in response to the RF trigger signal. However, because the controller 42 has previously located TPM sensor 22 (via the sensor ID) with respect to wheel 14, the controller 42 is configured to disregard TPM sensor signals having a sensor ID that identifies TPM sensor 22 as being the TPM sensor that generated the TPM sensor signals. Even still, the controller 42 records the sensor IDs and accesses the TPM sensor having the highest signal strength. Again, because TPM sensor 24 was intended to be triggered and polled in accordance with the triggering and polling sequences, TPM sensor 24 should have generated the TPM sensor signal with the highest signal strength. Accordingly, antenna 30 being located at the front-left wheel 16, which is in close proximity to wheel 16 and TPM sensor 24 enables the controller 42 to associate TPM sensor 24 with wheel 16. Controller 42 then stores this association in memory. Because wheels 14 and 16 have been associated with TPM sensors 22 and 24, respectively, controller 42 is configured to disregard TPM sensor signals having sensor IDs that match the IDs of TPM sensors 22 and 24 during subsequent locating of TM sensors. Nevertheless, for remaining TPM sensors that have not been located, they are triggered while their respective TPM antennas are polled until all vehicle TPM sensors have been properly located. After all TPM sensors have been located, the receiver 36 is configured to accurately provide data regarding specific wheels for display by display 46.

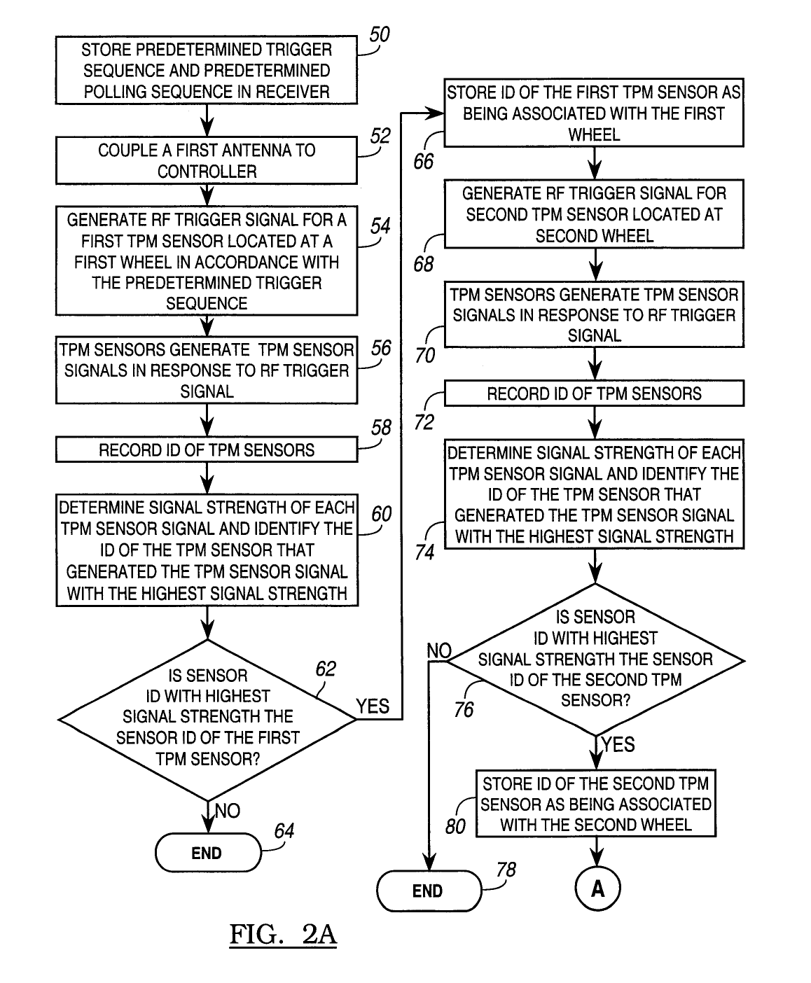

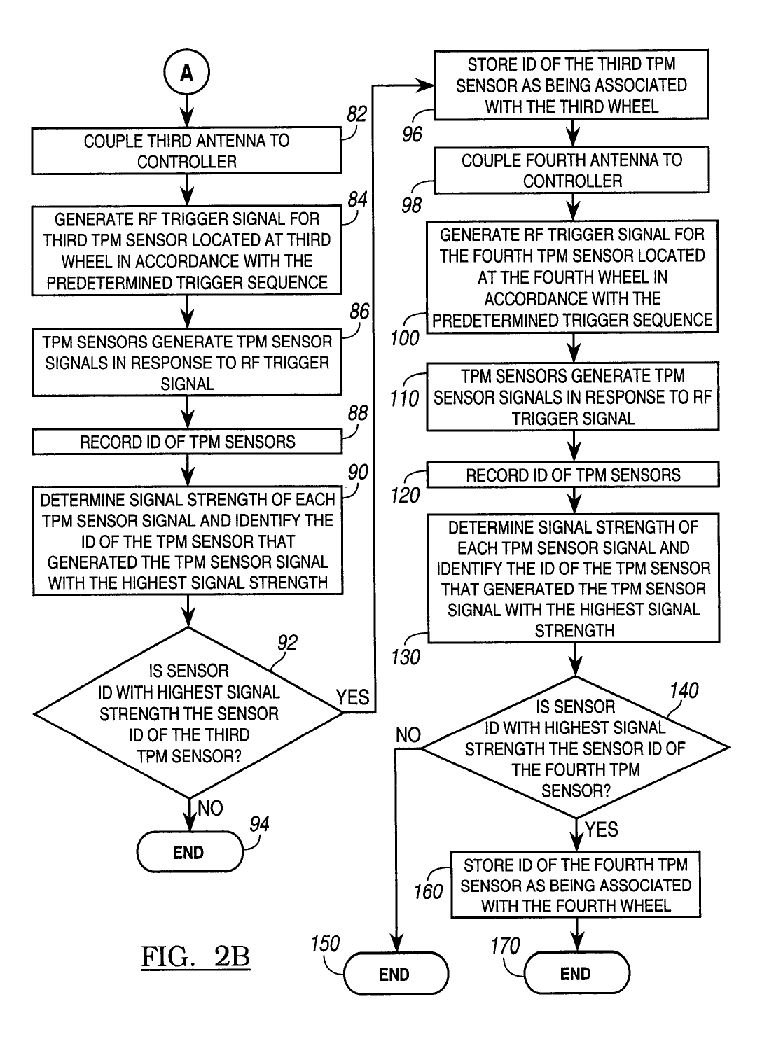

Now, referring to FIGS. 2A and 2B, a flow chart illustrates a method for associating TPM sensors with wheels on a vehicle. The flow chart begins at block 50 wherein the predetermined triggering sequence and predetermined program sequences are stored within the receiver via the controller. At block 52, the method includes coupling of a first antenna to the controller. At block 54, the RF trigger signal is generated for a first TPM sensor located at a first wheel in accordance with the predetermined trigger sequence. As depicted in block 56, the TPM sensors on the vehicle generate TPM sensor signals in response to the RF trigger signal. Block 58 depicts the recording of the TPM sensor IDs. As shown in block 60, the signal strength of each TPM sensor signal is determined and the ID of the TPM sensor having generated the TPM sensor signal with the highest signal strength is identified. Following block 60, block 62 occurs wherein the method determines whether the sensor ID with the highest signal strength is the sensor ID of the first sensor. If not, the method terminates at block 64. If so, a block 66 occurs wherein the ID of the first TPM sensor is associated with the first wheel and stored in the controller memory.

Block 68 depicts the RF trigger signal being generated for a second TPM sensor located at a second wheel in accordance with the predetermined trigger sequence and the predetermined polling sequence. As shown in block 70, the TPM sensors generate the TPM sensor signals in response to the RF trigger signal. Accordingly, the sensor IDs are recorded for each TPM sensor as shown at block 72. At block 74, the signal strength of each TPM sensor signal is determined. Additionally, at block 74 the ID of the TPM sensor that generated the TPM sensor signal with the highest signal strength is identified. Block 76 depicts the determination of whether the sensor ID with the highest signal strength is the sensor ID of the second TPM sensor. If the foregoing step at block 76 is not true the method ends at block 78. If the sensor ID with the highest signal strength is the sensor ID of the second TPM sensor a block 80 occurs. At block 80 the controller stores the ID of the second TPM sensor as being associated with the second wheel.

At block 82 a third antenna is coupled to the controller. As such, the RF trigger signal is generated for the third TPM sensor located at the third wheel in accordance with the predetermined trigger sequence. Block 86 depicts the TPM sensors generating the TPM sensor signals in response to the RF trigger signal. At block 88 the sensor IDs are again recorded for each TPM sensor. As described above, some sensor IDs may be disregarded including the IDs for those TPM sensors that have previously been associated with a specific wheel. At block 90, the signal strength of each TPM sensor signal is determined. Also, via the controller, the identification of the TPM sensor that generated the TPM sensor signal having the highest signal strength is identified. At block 92 the method determines whether the sensor ID with the highest signal strength is the sensor ID of the third TPM sensor. If not, the method terminates at block 94. If so, the controller stores the ID of the third TPM sensor as being associated with the third wheel as depicted by block 96.

Block 98 depicts coupling of a fourth antenna to the controller through the use of the antenna switch. At block 100 the RF trigger signal is generated for the fourth TPM sensor located at the fourth wheel in accordance with the predetermined trigger sequence and polling sequence. At block 110 the TPM sensors, in response to the RF trigger signal, generate the TPM sensor signals. At block 120 the IDs of the TPM sensors are recorded. As depicted by block 130 the controller determines the signal strength of each TPM sensor signal and identifies the ID of the TPM sensor that generated the TPM sensor signal with the highest signal strength. Block 140 depicts the determination of whether the sensor ID with the highest signal strength is the sensor ID of the fourth TPM sensor. If not, the method terminates at block 150. If so, the block 160 occurs wherein the controller stores the ID of the fourth TPM sensor as being associated with the fourth wheel. The method then ends at block 170.

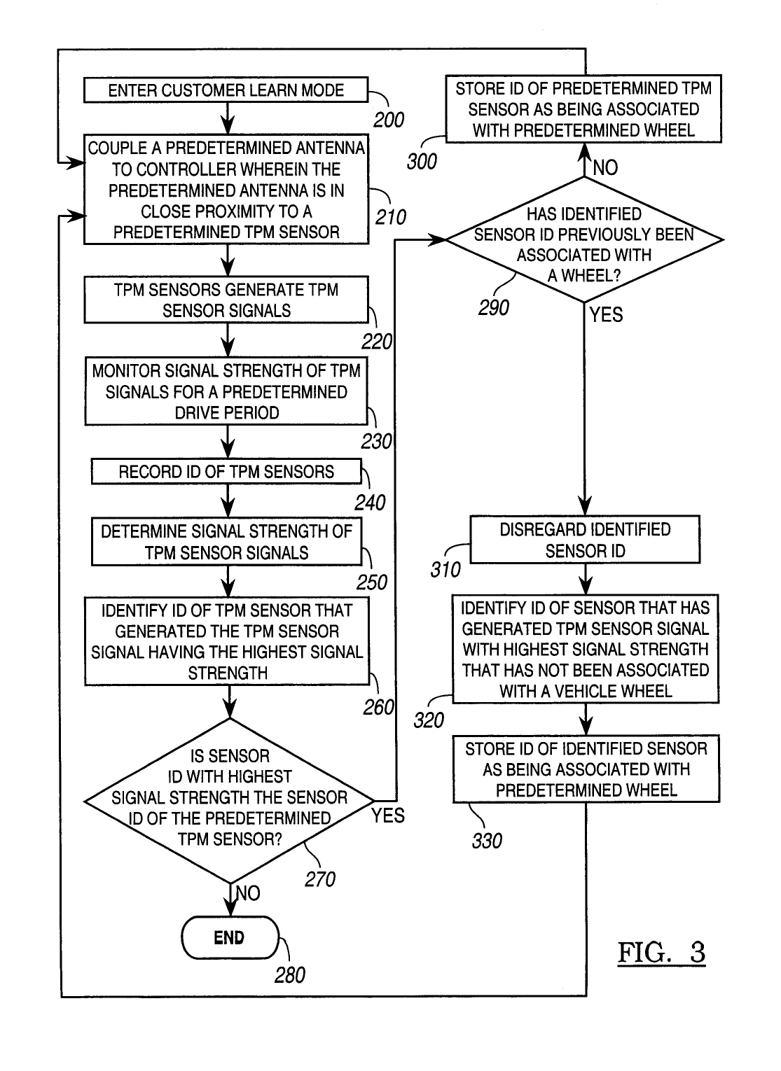

Now, referring to FIG. 3, another exemplary flow chart illustrates a method for teaching the TPM system the specific locations of TPM sensors with respect to vehicle wheels. Particularly, FIG. 3 illustrates the customer learn mode. The customer learn mode may be initiated by pressing a button located on a vehicle such as vehicle 12 in FIG. 1. Other means by which the customer learn mode may be entered include cycling of the vehicle ignition. Accordingly, block 200 illustrates entering the customer learn mode. As depicted by block 210, a predetermined antenna is coupled to the controller wherein the predetermined antenna is in close proximity to a predetermined TPM sensor. For example, during a first run through the method illustrated by FIG. 3, the predetermined antenna may be an antenna (e.g., antenna 29 in FIG. 1) in close proximity to a TPM sensor (e.g., TPM sensor 22 in FIG. 1) that is to be associated with a specific wheel location (e.g., wheel 14 in FIG. 1). During a second run through the method, for example, the predetermined antenna may be antenna 30 (FIG. 1) while the predetermined TPM sensor may be TPM sensor 24 (FIG. 1). During a third run through the method, the predetermined antenna may be antenna 32 while the predetermined TPM sensor may be TPM sensor 26.

Block 220 depicts the generation of TPM sensor signals by the TPM sensors located on the vehicle. As shown in block 230, the signal strength of the TPM signals is monitored for the predetermined drive period. This predetermined drive period may be a time period in a range of seconds to several minutes. As stated above, monitoring the TPM signals for the predetermined drive period enables the TPM system to ensure that the transmissions from the TPM sensors are normal transmissions and not undesirable transmission anomalies. Block 240 depicts the recording of TPM sensor IDs, which may be determined via the TPM sensor signals. Block 250 depicts a determination of the signal strength of TPM sensor signals as generated by the TPM sensors.

As shown in block 260, an identification of the ID of the TPM sensor that generated the TPM sensor signal having the highest signal strength occurs. At block 270, the method, through the use of the controller, determines whether the sensor ID with the highest signal strength is the sensor ID of the predetermined sensor. As described above, the predetermined sensor is the specific TPM sensor to be associated with a specific wheel on the vehicle. During a first run through the method illustrated by FIG. 3, the predetermined sensor may be sensor 22. During a second run, the predetermined sensor may be sensor 24. During a third and fourth run through the method, as illustrated by FIG. 3, the predetermined TPM sensor may be TPM sensors 26 and 28, respectively. Accordingly, as one predetermined TPM sensor is associated or located with respect to a specific vehicle wheel, the next TPM sensor to be associated with a vehicle wheel becomes the predetermined TPM sensor.

At block 270, if the sensor ID with the highest signal strength is not the sensor ID of the predetermined TPM sensor, the method ends at block 280. Alternatively, if block 270 is true (i.e., a YES), a block 290 occurs. As shown in block 290, the method includes a determination as to whether the identified sensor ID has been previously associated with a wheel. Block 290 enables the TPM system to assign those TPM sensor IDs that have not been previously associated with vehicle wheels to ensure optimal TPM system operation. As such, if the identified sensor ID has not been associated with a wheel, a block 300 occurs. As shown by block 300, the ID of the predetermined TPM sensor is associated with the predetermined wheel and stored in the memory of the controller. The predetermined wheel would be the wheel having the predetermined TPM sensor. For example, if the predetermined TPM sensor is sensor 24 (FIG. 1), then the predetermined wheel is wheel 16. Following block 300, block 210 occurs wherein each remaining antenna is coupled to the controller such that any remaining TPM sensors that have not been associated with a particular vehicle wheel can be accurately associated with specific vehicle wheel locations.

Referring back to block 290, if the identified sensor ID has been associated with a wheel, block 310 occurs wherein the identified sensor ID is disregarded. Accordingly, at block 320 the method includes identifying an ID of a TPM sensor that has generated a TPM sensor signal with the highest signal strength, which has not been associated with the vehicle wheel. At block 330, the ID of the identified sensor is stored as being associated with the predetermined wheel. Following block 330 the method returns to 210 as each TPM antenna is coupled to the controller such that the TPM sensor can associate any remaining TPM sensors with specific vehicle wheels.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A tire pressure monitoring (TPM sensors) system for a vehicle having multiple wheels, the system comprising:
a TPM sensor contained in each of the vehicle wheels, the sensor being configured to transmit TPM sensor signals;
a plurality of antennas for receiving the TPM sensor signals, wherein one antenna is positioned in close proximity to each TPM sensor; and
a receiver in communication with the antennas, the receiver having an antenna switch and a controller, the antenna switch enabling the TPM sensor signals to be received and processed by the controller, wherein the controller determines the location of the TPM sensor that transmitted the TPM sensor signal based on the processed TPM sensor signal.

2. The system of claim 1, wherein the antenna switch enables the TPM sensor signals to be received by the controller includes the antenna switch being configured to couple and de-couple each antenna from the controller.

3. The system of claim 2, wherein the antenna switch receives control signals from the controller to couple and de-couple each antenna from the controller.

4. The system of claim 3, wherein the receiver includes a radio-frequency (RF) receiver coupled to the antenna switch and the controller, the RF receiver being configured to process the TPM sensor signals received by the antennas so as to amplify the TPM sensor signals to be compatible with the controller.

5. The system of claim 1, wherein the one antenna being positioned in close proximity to each TPM sensor includes the antenna being affixed to a wheel well of the vehicle.

6. The system of claim 1, wherein the controller is configured to have a received signal strength indicator (RSSI) for accessing the signal strength of the TPM sensor signals received by the antennas; and
wherein the controller determines the location of the TPM sensor that transmits the TPM sensor signal based on the processed TPM sensor signal by polling each antenna for the transmitted TPM sensor signal and accessing the signal strength of the TPM sensor signals received from each antenna.

7. The system of claim 6, wherein the controller polls each antenna by generating signals for the antenna switch to couple each antenna to the controller in accordance with a predetermined polling sequence; and
wherein the TPM sensor signals include a sensor identification that indicates the TPM sensor that transmitted the TPM sensor signal.

8. The system of claim 6, further comprising a triggering device for generating an RF trigger signal that causes the TPM sensor to generate the TPM sensor signals, wherein the triggering device has a predetermined triggering sequence by which the RF trigger signal is generated for each TPM sensor; and
wherein the controller is programmed to determine when the RF trigger signal is generated for each TPM sensor in accordance with the predetermined triggering sequence, the controller determining the location of the TPM sensor through polling each antenna in accordance with the predetermined polling sequence and identifying the TPM sensor signal having the highest signal strength in conjunction with the generation of the RF trigger signal for each TPM sensor.

9. The system of claim 8, wherein each TPM sensor signal includes a sensor signal identification that identifies which TPM sensor transmitted the TPM sensor signal.

10. A method for determining a location of TPM sensors on a vehicle with respect to vehicle wheels, wherein the vehicle has multiple wheels each having a TPM sensor, the method comprising:
transmitting TPM sensor signals via the TPM sensors, wherein the TPM sensor signals include a sensor identification for the TPM sensors that generated the TPM sensor signals;
receiving the TPM sensor signals at a plurality of antennas, wherein one antenna is positioned in close proximity to each TPM sensor;
receiving the TPM sensor signals at a receiver that is in communication with the antennas, the receiver having an antenna switch and a controller, the antenna switch enabling the TPM sensor signals to be received and processed by the controller; and
determining the location of each TPM sensor on each wheel that transmitted the TPM sensor signals based on the sensor identification as processed through the use of the controller.

11. The method of claim 10, wherein the antenna switch enables the TPM sensor signals to be received by the controller includes the antenna switch being configured to couple and de-couple each antenna from the controller.

12. The method of claim 11, wherein the antenna switch receives control signals from the controller to couple and de-couple each antenna from the controller.

13. The method of claim 12, wherein the receiver includes a radio-frequency (RF) receiver coupled to the antenna switch and the controller, the RF receiver being configured to process the TPM sensor signals received by the antennas so as to cause the TPM sensor signals to be compatible with the controller.

14. The method of claim 10, wherein the one antenna being positioned in close proximity to each TPM sensor includes the antenna being affixed to a wheel well of the vehicle.

15. The method of claim 10, wherein the controller is configured to have a received signal strength indicator (RSSI) for accessing the signal strength of the TPM sensor signals received by the antennas;
wherein the controller determines the location of the TPM sensor that transmits the TPM sensor signal based on the sensor identification as processed by the controller by polling each antenna for the transmitted TPM sensor signal and accessing the signal strength of the TPM sensor signals received from each antenna; and
wherein the TPM sensor that generated the TPM sensor signal having the highest signal strength is associated with a first wheel through the use of the sensor identification.

16. The method of claim 15, wherein the controller has memory storage, the controller storing in memory the sensor identification of the TPM sensor that generated the TPM sensor signal having the highest signal strength as being associated with the first wheel.

17. The method of claim 15, wherein the controller polls each antenna by generating signals for the antenna switch to couple each antenna to the controller in accordance with a predetermined polling sequence.

18. The method of claim 17, further comprising generating an RF trigger signal that causes the TPM sensors to generate the TPM sensor signals, wherein the RF trigger signal is generated in accordance with a predetermined triggering sequence; and
wherein the controller is programmed to determine when the RF trigger signal is generated for each TPM sensor in accordance with the predetermined triggering sequence.

19. The method of claim 10, wherein the receiver and the antennas are coupled to the receiver through the use of a twisted pair wire.

20. A tire pressure monitoring (TPM sensors) system for associating one TPM sensor with one wheel on a vehicle, wherein the vehicle has a plurality of TPM sensors that include the one TPM sensor and a plurality of wheels that include the one wheel, the system comprising:
a triggering device for generating a radio-frequency (RF) trigger signal for each TPM sensor in accordance with a predetermined triggering sequence, wherein the TPM sensors transmit a TPM sensor signal upon receipt of the RF trigger signal,
wherein the TPM sensor signal includes a sensor identification that indicates which TPM sensor transmitted the TPM sensor signal;
a plurality of antennas for receiving the TPM sensor signals, wherein one antenna is positioned in close proximity to each TPM sensor;
a receiver in communication with the antennas, the receiver having an antenna switch and a controller, the antenna switch allowing polling of each TPM sensor in accordance with a predetermined polling sequence by selectively coupling each antenna, individually, to the controller to enable each transmitted TPM sensor signal to be received and processed by the controller, wherein the controller has in memory the predetermined triggering sequence, and the controller associates the one TPM sensor with the one wheel by:
(a) determining a signal strength of each TPM sensor signal from each TPM sensor to identify the TPM sensor that generated the TPM sensor signal having a highest signal strength;
(b) identifying which TPM sensor has been triggered by the RF trigger signal in accordance with the predetermined triggering sequence; and
(c) associating the one TPM sensor with the one wheel when the one TPM sensor generates the TPM sensor signal having the highest signal strength and the one TPM sensor was triggered by the RF trigger signal in accordance with the predetermined triggering sequence; and
wherein the controller stores in memory the sensor identification of the one TPM sensor being associated with the one wheel.
